(19) United States
(12) Patent Application Publication
(10) Pub. No.: US 2022/0266344 A1
(43) Pub. Date: Aug. 25, 2022

(54) BUILD PLATE WITH THERMALLY DECOMPOSING TOP SURFACE FOR FACILE RELEASE OF 3D PRINTED OBJECTS

(71) Applicant: INDIUM CORPORATION, Utica, NY (US)

(72) Inventors: David P. Socha, Whitesboro, NY (US); Mark K. Olearczyk, Barneveld, NY (US)

(21) Appl. No.: 17/678,820

(22) Filed: Feb. 23, 2022

Related U.S. Application Data
(60) Provisional application No. 63/152,785, filed on Feb. 23, 2021.

(51) Int. Cl. B22F 12/30; B29C 64/245; B33Y 10/00; B33Y 30/00

(52) U.S. Cl. CPC B22F 12/30; B29C 64/245; B33Y 10/00; B33Y 30/00

(57) ABSTRACT

Thermally decomposable build plates that enable the facile release of 3D printed parts are described. In one implementation, an additive manufacturing build plate comprises: a body including a top surface, a bottom surface, and sidewalls dimensioned such that the build plate is useable in a 3D printing device; and a layer of a solid metal or metal alloy on the top surface of the additive manufacturing build plate, the layer having a solidus temperature that is lower than a solidus temperature of the body, and the layer configured to provide a surface for forming a 3D object in the 3D printing device. In one implementation, an additive manufacturing build plate comprises a recessed section for receiving an insert including a layer of a solid metal or metal alloy on a surface of the insert.

### CROSS-REFERENCE TO RELATED APPLICATIONS

The present application claims the benefit of U.S. Provisional Patent Application No. 63/152,785 filed on Feb. 23, 2021 and titled “BUILD PLATE WITH THERMALLY DECOMPOSING TOP SURFACE FOR FACILE RELEASE OF 3D PRINTED OBJECTS,” which is incorporated herein by reference in its entirety.

### DESCRIPTION OF THE RELATED ART

3D printing, also known as additive manufacturing, involves depositing print material into sequential layers onto a build plate until the desired 3D print is formed. 3D printing methods build parts layer by layer, but most require a platform or build plate to serve as the starting point. The first few layers of print material will bond onto the surface of the build plate, and the following layers build on this surface.

3D plastic printed parts may use plastic powder or plastic cord as feedstock, combined with a binder. A UV source or thermal treatment solidifies and shapes the object layer by layer. The final step is to remove the plastic 3D printed object from the build plate with a light force and/or some mild scraping.

3D metal printed parts are printed on a build plate. The feedstock is made of metal powders or combination of powders. The build plate is placed into the 3D printing machine. Once the machine is activated, a blade deposits a layer of metal powder over the build plate. A laser or series of lasers selectively sinters the metal that will become part of the 3D printed object. The first few passes of the laser essentially weld what will become the 3D printing object to the build plate. The blade then deposits new powdered metal across the surface of the build plate. Selective sintering is repeated and the object is created layer by layer.

Once the printing process is complete, the bond between the print material and the build plate will need to be broken for the printed object to be removed from the build plate. The bond between the print material and the surface of the build plate may make it difficult to separate the 3D printed object from the build plate following completion of the print process. To remove print material from the build plate, a user may be required to employ tools such as a band saw or wire electrical discharge machining (EDM) machine, or other means, to mechanically separate the print material from the build plate.

### SUMMARY

Some implementations of the disclosure are directed to a thermally decomposable build plate that enables the facile release of 3D printed parts created by additive manufacturing.

In one embodiment, an additive manufacturing build plate comprises a body including a top surface, a bottom surface, and sidewalls dimensioned such that the build plate is useable in a 3D printing device; and a layer of a solid metal or metal alloy on the top surface of the additive manufacturing build plate, the layer having a solidus temperature that is lower than a solidus temperature of the body, and the layer configured to provide a surface for forming a 3D object in the 3D printing device.

In some implementations, the layer has a thickness between 100 μm and 13 mm.

In some implementations, the body has a thickness between 6 mm and 50 mm from the top surface to the bottom surface.

In some implementations, the additive manufacturing build plate consists of the body and the layer of the solid metal or metal alloy.

In some implementations, the layer is thermally sprayed, evaporated, wave soldered, electroplated, sputtered, painted, cladded, spin-coated, or applied by doctor blade on the top surface of the body.

In some implementations, the additive manufacturing build plate further comprises the 3D object printed on the layer, wherein the solid metal or metal alloy has a solidus temperature that is lower than a solidus temperature of the 3D object.

In some implementations, the body is a single part including the top surface, the bottom surface, and the sidewalls.

In some implementations, the top surface is flat.

In some implementations, the additive manufacturing build plate comprises one or more holes extending through the body, the one or more holes configured to receive one or more structural protrusions of the 3D printing device to hold the additive manufacturing build plate in place during 3D printing.

In one embodiment, an additive manufacturing system comprises: a build plate useable within a 3D printing device, the build plate including a body having a recessed section formed through a surface of the body; an insert dimensioned to be inserted into the recessed section; and a layer of a solid metal or metal alloy on a surface of the insert, the layer having a solidus temperature that is lower than a solidus temperature of the build plate and a solidus temperature of the insert, and the layer configured to provide a surface for forming a 3D object in the 3D printing device.

In some implementations, the recessed section comprises a hole extending through a bottom surface of the build plate.

In some implementations, layer has a thickness between 100 μm and 13 mm.

In some implementations, the build plate has a thickness between 6 mm and 50 mm from a top surface to a bottom surface of the build plate.

In some implementations, the insert has a thickness between 2 mm and 10 mm.

In some implementations, the layer is thermally sprayed, evaporated, wave soldered, electroplated, sputtered, painted, cladded, spin-coated, or applied by doctor blade on the surface of the insert.

In some implementations, the additive manufacturing build plate of the additive manufacturing system further comprises one or more holes extending through the body, the one or more holes configured to receive one or more structural protrusions of the 3D printing device to hold the additive manufacturing build plate in place during 3D printing.

In one embodiment, a method comprises: obtaining a build plate useable within a 3D printing device, the build plate including a body having a recessed section formed through a surface of the body; and securing an insert within the recessed section, the insert having a layer of a solid metal or metal alloy on a surface of the insert, and the layer having a solidus temperature that is lower than a solidus temperature of the build plate and a solidus temperature of the insert.

In some implementations, the method further comprises: after securing the insert, positioning the build plate within the 3D printing device; printing, using the 3D printing device, a 3D printed object onto the layer, wherein the layer has a lower solidus temperature than the 3D printed object; and after printing the 3D printed object, melting the layer to release the 3D printed object from the insert.

In some implementations, the method further comprises: after printing the 3D printed object and before melting the layer: removing the insert with the 3D printed object from the recessed section of the build plate.

In some implementations, the recessed section comprises a hole extending through a bottom surface of the build plate; and removing the insert with the 3D printed object from the recessed section of the build plate, comprises: applying pressure to the insert from an underside of the build plate through the hole extending through the bottom surface of the build plate.

In some implementations, the method further comprises: removing the insert with the 3D printed object from the recessed section of the build plate; and securing, within the recessed section, a second insert.

Other features and aspects of the disclosed technology will become apparent from the following detailed description, taken in conjunction with the accompanying drawings, which illustrate, by way of example, the features in accordance with implementations of the disclosed technology. The summary is not intended to limit the scope of any inventions described herein, which are defined by the claims and equivalents.

It should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The present disclosure, in accordance with one or more implementations, is described in detail with reference to the following figures. The figures are provided for purposes of illustration only and merely depict example implementations. Furthermore, it should be noted that for clarity and ease of illustration, the elements in the figures have not necessarily been drawn to scale.

Some of the figures included herein illustrate various implementations of the disclosed technology from different viewing angles. Although the accompanying descriptive text may refer to such views as “top,” “bottom” or “side” views, such references are merely descriptive and do not imply or require that the disclosed technology be implemented or used in a particular spatial orientation unless explicitly stated otherwise.

FIG. 1A shows a top view of a build plate that can be used for 3D printing in accordance with implementations of the disclosure.

FIG. 1B shows a bottom view of the build plate of FIG. 1A.

FIG. 1C shows a side view of the build plate of FIG. 1A.

FIG. 2 illustrates a 3D metal printing process including a 3D metal printing device using a metal powder bed and a laser to form a 3D printed object on a build plate, in accordance with implementations of the disclosure.

FIG. 3 shows an assembly including a 3D printed object metallurgically joined onto a top surface of a build plate after the completion of 3D printing, in accordance with implementations of the disclosure.

FIG. 4 depicts the 3D printed object of FIG. 3 after being separated from the build plate once the intermediary layer is no longer solid and melted away, in accordance with implementations of the disclosure.

FIG. 5A shows an exploded perspective view of a build plate assembly including an insert and build plate that can be used for 3D printing in accordance with implementations of the disclosure.

FIG. 5B shows a top view of the build plate assembly of FIG. 5A.

FIG. 5C shows a side view of the build plate assembly of FIG. 5A.

FIG. 6 shows an assembly including a 3D printed object metallurgically joined onto a top surface of a build plate assembly after the completion of 3D printing, in accordance with implementations of the disclosure.

FIG. 7 depicts the build plate assembly of FIG. 6 after the insert is removed from the build plate, in accordance with implementations of the disclosure.

The figures are not exhaustive and do not limit the present disclosure to the precise form disclosed.

### DETAILED DESCRIPTION OF THE EMBODIMENTS

There is a need for improving techniques in additive manufacturing for removing workpieces that are essentially welded to a build plate. One challenge is to free the parts without damaging them, but also to protect the build plate so that it can be reused. As noted above, mechanical means, such as by use of a bandsaw or wire EDM, are typically employed to cut and remove a 3D printed from a build plate outside of the 3D printer. The build plate may then be machined separately to remove excess material and return them to a usable state. Such separation techniques, however, may be problematic.

Current mechanical removal approaches may lead to damage of the 3D printed part, damage to the surface of the build plate, and/or injury to the user. First, mechanical removal of the part by cutting may require hours of post processing to bring the 3D printed part back to its desired shape. Second, by cutting the 3D printed part away from the build plate, a portion of the welded part (post) requires grinding to remove that remaining piece from the build plate and to return the build plate to a smooth surface for reuse. This process of ensuring that all printed material is removed from a build plate before beginning a new printing process may be tedious and time consuming, as well as potentially harmful to the build plate. Moreover, mechanical removal techniques such as using a bandsaw or wire EDM require 3D printed parts to have a standoff between the part and the build plate to allow access for the band saw or wire EDM clearance, which requires additional, consumable metal powder.

Although not taught for removal of 3D metal printed/laser sintered parts from a build plate, a chemical removal method has been proposed for separating 3D printed support structures from a 3D printed object. By applying this method, certain areas of a metal additive manufacturing part react chemically when immersed in a corrosive solution. The technique involves a controlled degradation that eats away at the supports while leaving actual part virtually intact. This process may use sodium hexacyanoferrate as a sensitizing agent. Although this chemical etching process of support and part removal may reduce the removal and post processing time of traditional machining, it relies on the application of corrosive chemicals.

To address the aforementioned deficiencies of the art, the present systems and methods described in the disclosure are directed to simplifying 3D printed object removal from a build plate without the use of expensive saws, complex machines, or harsh chemicals. In accordance with implementations of the disclosure, a thermally decomposable build plate may enable the facile release of 3D metal printed parts created by additive manufacturing. During 3D metal printing or laser sintering, a print material may bond onto a surface of the build plate having a lower melting temperature than the print material and the rest of the build plate. Once the printing process is completed, the assembly may be treated with heat, thereby melting the bond surface between the 3D printed object and the build plate, and releasing the 3D printed object.

In contrast to mechanical removal of a 3D printed metal part that often necessitates hours of post processing to reshape and polish the bottom of the object and to resurface the build plate for reuse, by applying the systems and methods described herein, a facile removal of a 3D printed object from a build plate may be enabled without damage to the 3D printed part. Little or no post processing, finishing, reshaping, and/or polishing the 3D printed object may be needed by applying the 3D printed part removal systems and methods disclosed herein. Moreover, by virtue of applying the systems and methods described herein, object removal from a build plate may be accelerated without the use of corrosive chemicals, thereby offering a user additional time and cost-savings in additive manufacturing.

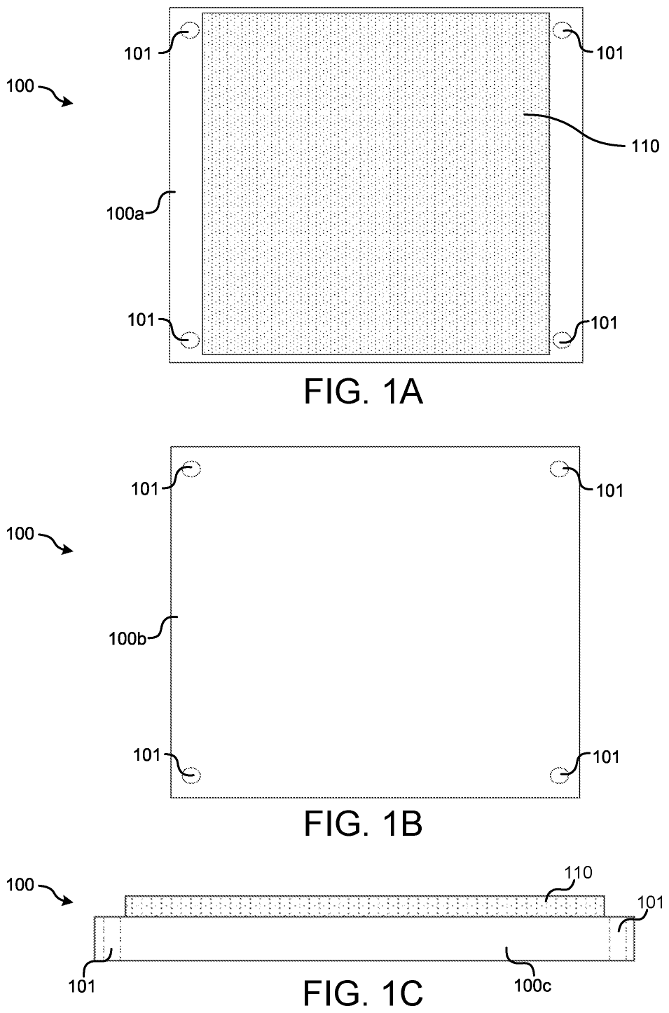

FIGS. 1A, 1B, and 1C respectively show top, bottom, and side views of a build plate 100 that can be used for 3D printing in accordance with implementations of the disclosure. As shown, build plate 100 includes a top surface 100a, a bottom surface 100b and four sidewalls 100c that extend between the top and bottom surfaces. The build plate 100, including the top, bottom, and side surfaces, may be made of copper, stainless steel, tool steel, tin, aluminum, cemented carbide, ceramic, graphite, or some other suitable material. In particular, as further described below, the build plate 100 may be made of material (e.g., metal or metal alloy) having a solidus temperature that is substantially higher (e.g., at least 30° C.) than that of a thermally decomposable material of a layer or film 110 that is adhered to the top surface 100a of the build plate 100 to create a bond between build plate 100 and a 3D printed object during 3D printing. For example, the build plate 100 may have a melting temperature that is greater than 1000° C.

Although depicted in the shape of a rectangular prism or cuboid having sidewalls that extend perpendicularly between the top surface 100a and bottom surface 100b, it should be noted that in other implementations build plate 100 may be some other suitable shape, e.g., a trapezoidal prism or circular shape, that may be used to implement the 3D printing techniques described herein.

In this example, means for attachment of build plate 100 to a 3D printing apparatus are represented by slots or holes 101 (e.g., bolt holes) in each corner of build plate 100. Structural protrusions (e.g., bolts or tabs) of the 3D printing apparatus may be inserted into holes 101 to hold the build plate 100 in place during 3D printing. Although holes 101 are illustrated in each corner of top surface 100a, it should be appreciated that depending on the implementation, build plate 100 may include holes 101 and/or protrusions in any suitable location on top surface 100a, bottom surface 100b, and/or other surface of build plate 100 to facilitate attachment to the 3D printing apparatus. In some implementations, holes 101 may be included on bottom surface 100b and not on top surface 100a to prevent powdered metal from 3D printing to fall into holes 101.

As depicted, build plate 100 has a layer 110 of a metal or metal alloy applied on its top surface 100a. Layer 110 serves as an intermediary layer on which the 3D object is printed. The solidus temperature of the layer 110 is lower than both the material comprising the build plate 100 and a material used to form the 3D printed object. The layer 110 of thermally decomposable material may be a solid metal or metal alloy having a solidus temperature of less than 300° C. In some implementations, it has a solidus temperature between 50° C. and 250° C. For example, the solid material may be a solder alloy such as tin alloys (e.g., 96.5Sn3Ag0.5Cu), bismuth alloys (e.g., 58Bi42Sn) or indium alloys (e.g., 52In48Sn). In other implementations, the solid material may be a single elemental metal such as tin, bismuth, indium, or others.

The solidus temperature of the metal or metal alloy may be at least 30° C. lower than that of the build plate 100. In some implementations, the differences in melting point may be more significant. For example, in some implementations the solidus temperature of the metal or metal alloy may be at least 50° C. lower, 100° C. lower, 200° C. lower, 400° C. lower, 600° C. lower, 800° C. lower, 1000° C. lower, or even more than 1000° C. lower than the solidus temperature of the build plate 100.

The intermediary layer 110 can be adhered to the build plate by a variety of methods. Such methods for depositing layer 110 onto the build plate 100 include thermal spraying, evaporation, wave soldering, electroplating, sputtering, painting, cladding, spin-coating, applying by doctor blade, or other means. The top surface 100a of build plate 100 may be substantially flat to facilitate deposition of the intermediary layer 110.

Variations of the structure above could also be employed. For example the top surface 100a of the build plate 100 could first be thermally sprayed with a metal such as indium and subsequently cold-welded to a thin foil of indium to serve as the build surface.

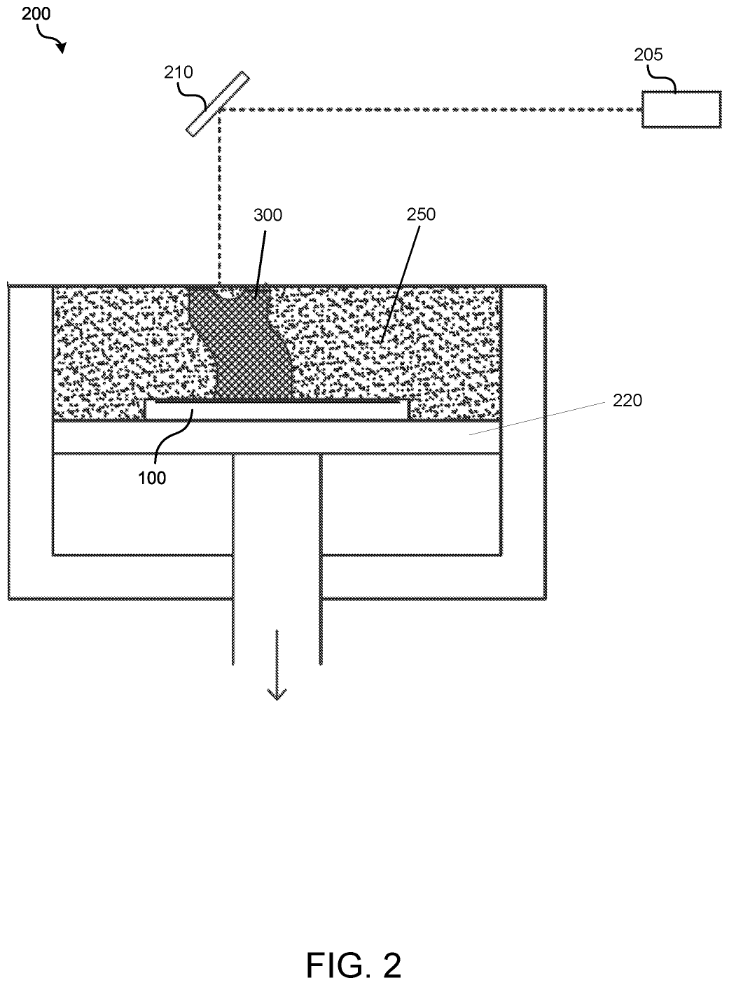

FIG. 2 illustrates a 3D metal printing process including a 3D metal printing device 200 using a metal powder bed 250 and a laser 205 to form a 3D printed object 300 on a build plate 100, in accordance with implementations of the disclosure. Also shown is build plate loading platform 220 and optical component 210 for directing the output of a laser 205. The metal powder bed 250 may comprise aluminum, cobalt, copper, nickel, steel, stainless steel, titanium, vanadium, tungsten carbide, gold, bronze, platinum, silver alloys, cobalt-chromium alloys, refractory metals, a combination thereof, or some other suitable metal or metal alloy for forming 3D printed object 300. The 3D printed object 300 may be laser sintered. Prior to beginning printing, a build plate 100 having a layer 110 of a low melting temperature metal or metal alloy applied on its top surface 100a may be loaded into the 3D metal printing device 200. For example, build plate 100 may be placed on a platform 220 of device 200.

At the start of printing, a first layer of metal powder may be deposited (e.g., using a doctor blade or wiper blade) over the top surface of build plate 100, including layer 110. Laser 205 or a series of lasers may then lase/sinter the deposited metal powder, causing the first layer of 3D printed object 300 to be metallurgically joined to the solid material of layer 110. Thereafter, additional layers of powdered metal may be deposited by metal powder bed 250 and 3D printed object 300 may be created layer by layer. The device 200 may include a lowering mechanism (e.g., as part of platform 220) apparatus to allow for subsequent metal layers of the 3D printed object 300 to be formed. As the apparatus and build plate are lowered, a metal powder layer may be added to the top surface and a laser or laser(s) used to selectively join/sinter areas to the 3D printed object 300 below. At the completion of the aforementioned 3D printed process, build plate 100 with 3D printed object 300 may be removed from 3D printing device 200.

The melting temperature of the metal or metal alloy that is used to form 3D printed object 300 is higher than that of the solid material of layer 110. For example, similar to the build plate 100, the solidus temperature of the 3D printed object 300 may be at least 30° C. higher than the solidus temperature of the metal or metal alloy. In some implementations, the differences in melting point may be more significant. For example, in some implementations the solidus temperature of the 3D printed object 600 may be 50° C. higher, 100° C. higher, 200° C. higher, 400° C. higher, 600° C. higher, 800° C. higher, 1000° C. higher, or even more than 1000° C. higher than the solidus temperature of the metal or metal alloy of the solid material of layer 110. In some implementations, the metal powder used to form 3D printed object 300 may comprise aluminum, cobalt, copper, nickel, steel, stainless steel, titanium, vanadium, tungsten carbide, gold, bronze, platinum, silver alloys, cobalt-chromium alloys, refractory metals, a combination thereof, or some other suitable metal or metal alloy.

It should be noted that although 3D printing may occur at room temperature, the heat generated by laser 205 may increase the temperature of the solid material of layer 110. To prevent premature melting of the solid material during 3D printing, this increase in temperature may be accounted for when selecting a suitable metal or metal alloy. In some implementations, the power of laser 205 may be decreased while forming lower layers of 3D printed object 300 to prevent overheating of the material of layer 110 during 3D printing.

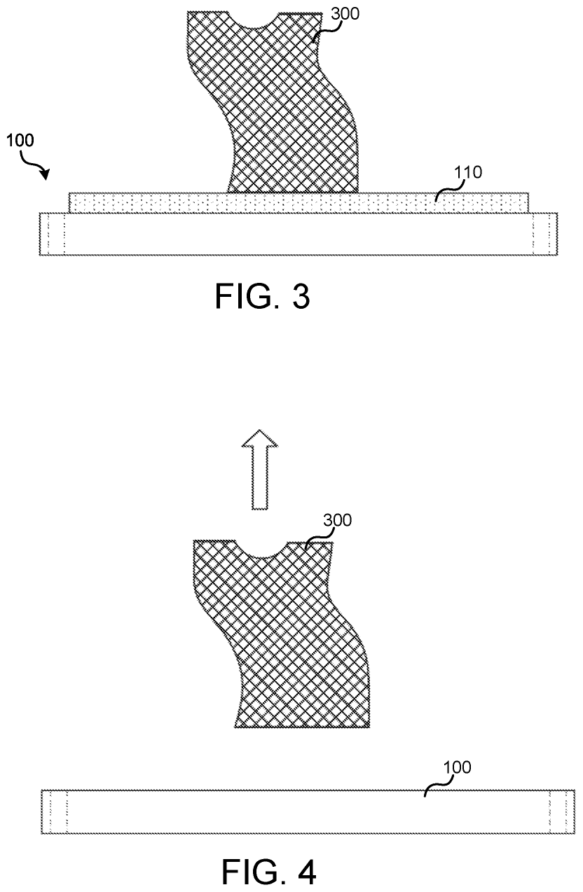

After completion of the print, the build plate 100 is removed from the machine and the 3D printed object 300 is separated from the build plate 100. FIG. 3 shows a side view of an assembly including the 3D printed object 300 metallurgically joined onto build plate 100 after the completion of 3D printing. In particular, the 3D printed object 300 may be joined to a surface of build plate 100 containing a layer 110 of a low melting temperature solid material, as described above.

To separate 3D printed object 300 from build plate 100, the assembly may be heated (e.g., by placing the assembly in an oven) such that intermediary layer 110 melts, releasing the 3D printed object 300. The assembly may be placed into a container with a heated medium or subjected to other thermal treatment to cause the separation. FIG. 4 depicts the 3D printed object 300 after being separated from the build plate 100 once the intermediary layer 110 is no longer solid and melted away. As depicted, the build plate 100 and 3D printed object 300 may remain intact after the heat treatment. The heat treatment may exceed the solidus temperature of the intermediary layer 110 while remaining below the solidus temperature of the build plate 100 and 3D printed object 300. A solid to liquid or solid to plastic-like phase change occurs in the intermediary layer 110 in which the 3D printed object 300 can be removed from the surface with minimal effort, without the need for mechanical removal tools such as a band saw or wire electrical discharge machinery.

The heat source is not limited to that of an oven. In other implementations, the 3D printed object 300 may be thermally separated from the intermediary layer 110 by a heat source other than an oven such as by blow torch, heated air, heated liquid, hotplate, laser, or any other suitable heat source sufficient to melt the intermediary layer 110, thereby releasing the 3D printed object 300.

In some implementations, the melted metal or metal alloy or layer 110 may be collected and, after separation of 3D printed object 300, used to refixture the object 300 for polishing, reshaping, and/or grinding, as needed. For example 3D printing parts may be held using a clamping mechanism for post processing. The lower melting point material may be used to secure the 3D printed object 300 into a vice or clamping mechanism while performing the post processing functions above, so that the clamp does not contact the 3D printed object 300 directly.

In some implementations, it may be advantageous to apply a layer of the lower melting temperature metal or metal alloy onto an insert placed in the build plate rather than directly onto the build plate. This may improve manufacturing throughput as, instead of subjecting the build plate to the heat treatment, the insert may be immediately removed with the 3D printed object and replaced with another insert coated with the low melting temperature metal in order to reuse the build plate for 3D printing another object. In addition, this may help extend the life of the build plate.

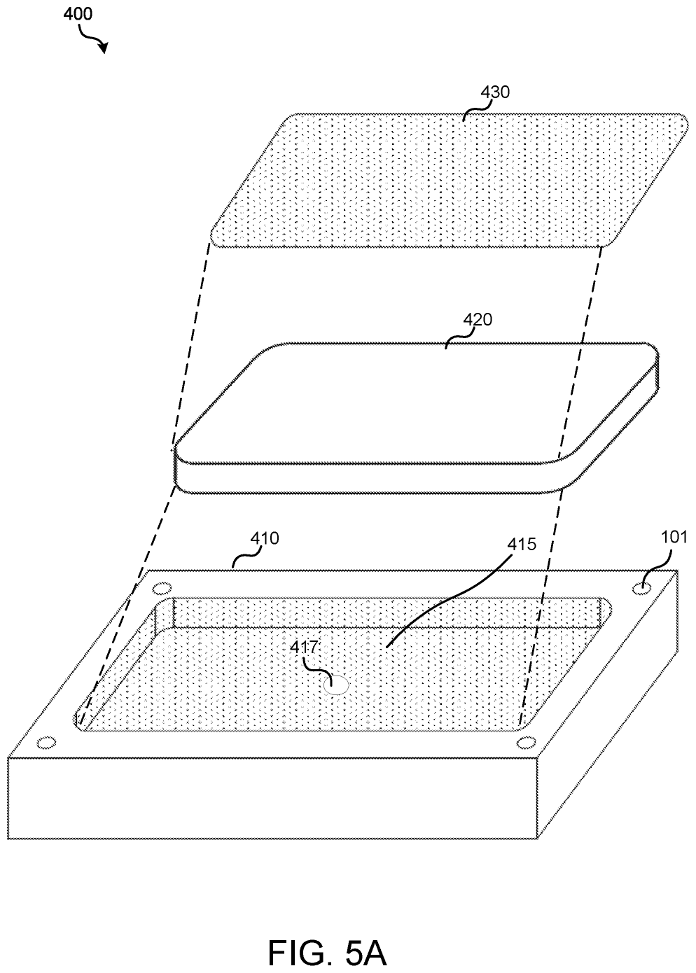

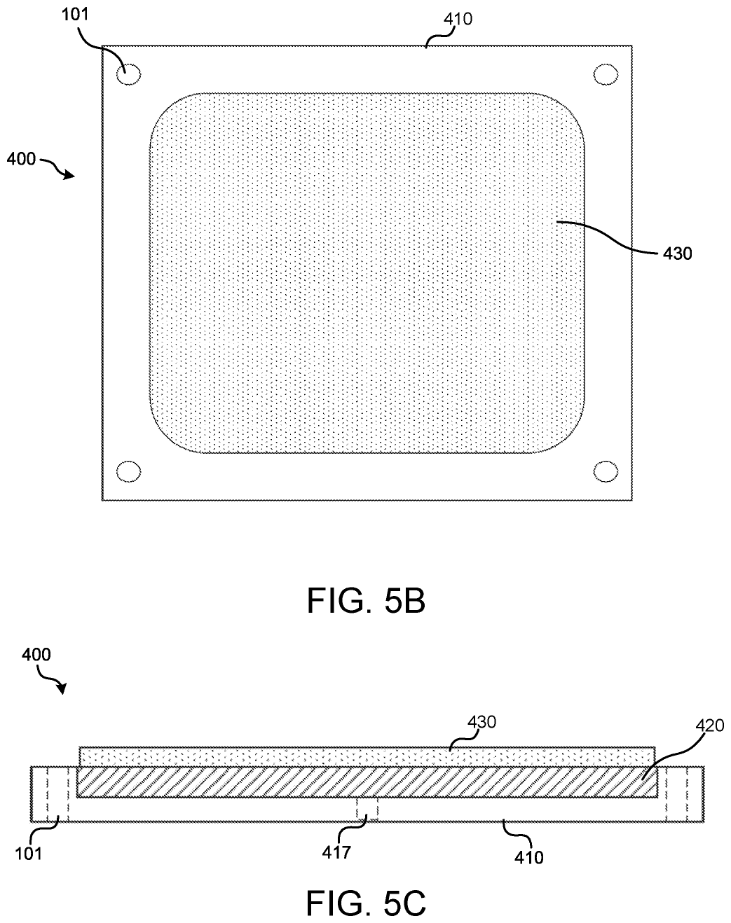

To this end, FIGS. 5A-5C depict a build plate assembly 400 including a recessed build plate 410, an insert 420, and intermediary layer 430 applied on the insert 420. FIGS. 5A, 5B, and 5C respectively show exploded perspective, top, and side views of the build plate assembly 400. Insert 420 may be a pre-shaped solid insert that may be snapped or otherwise secured into or out of recessed section 417 of recessed build plate 410. The insert 420 may be dimensioned such that it fits securely (e.g., occupies substantially all of the open volume) within the recessed section 415. In such instances, multiple duplicate molds of the solid insert 420 may be formed, with each mold being utilized during a 3D printing process.

In this implementation, the intermediary layer 430 of metal or metal alloy has a solidus temperature lower than that of the material comprising the build plate 410, the material comprising the insert 420, and the material comprising the 3D printed object. In this implementation, the build plate 410 and insert 420 may be made of the same or different materials. For example, the build plate 410 and/or insert 420 may be made of copper, stainless steel, tool steel, tin, aluminum, cemented carbide, ceramic, graphite, or some other suitable material.

The insert 420, containing the layer 430 of metal or metal alloy on its top side, is fitted into the recessed section 415 of the build plate 410. The metal or metal alloy on the insert surface serves as an intermediary layer 430 on which the 3D object is printed.

The intermediary layer 430 can be adhered to the insert 420 by a variety of methods. Such methods for depositing layer 430 onto the insert 420 include thermal spraying, evaporation, wave soldering, electroplating, sputtering, painting, cladding, spin-coating, applying by doctor blade, or other means. The top surface of insert 420 may be substantially flat to facilitate deposition of the intermediary layer 430. In some implementations, the top surface of the insert 420 could first be thermally sprayed with a metal such as indium and subsequently cold-welded to a thin foil of indium to serve as the build surface.

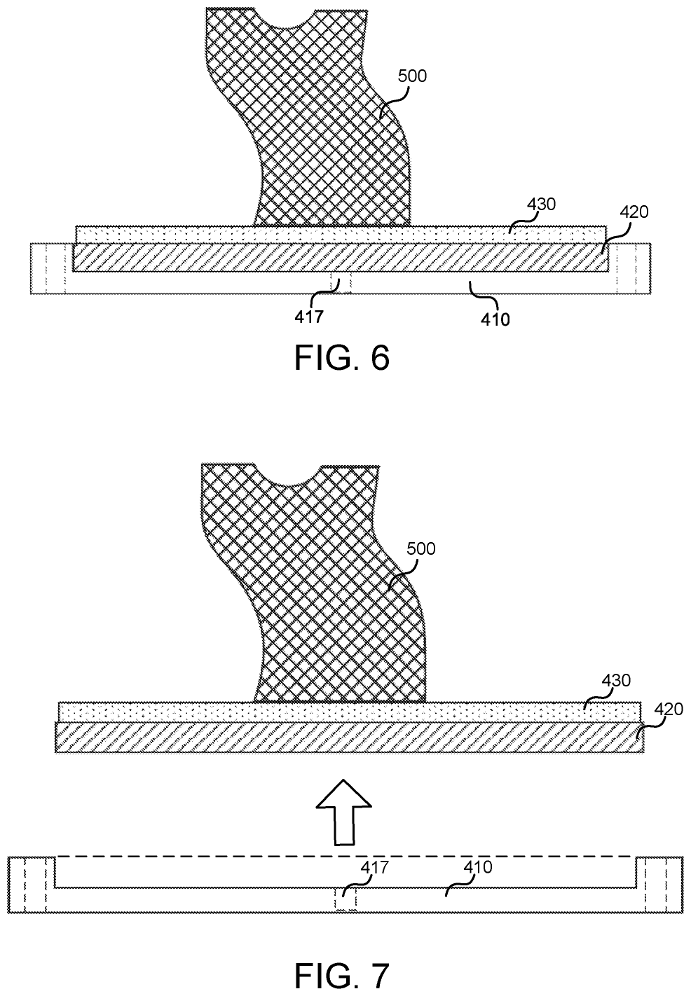

The build plate assembly 400 may be loaded onto a build plate loading platform of a 3D metal printing device 200, and the 3D metal printing device 200 may print a 3D printed object on intermediary layer 430 of build plate assembly 400 in a manner similar to that discussed above with reference to printing 3D printed object 300 on intermediary layer 110 of build plate 100. Upon completion of the print, the build plate assembly 400 is removed from the machine 200. FIG. 6 shows a side view of an assembly including a 3D printed object 500 metallurgically joined onto build plate assembly 400 after the completion of 3D printing. In particular, the 3D printed object 500 may be joined to a surface of insert 420 containing a layer 430 of a low melting temperature solid material, as described above.

In this case, the snap-in insert may make operation of the 3D printing system more convenient and simpler for the operator. When an operator completes 3D printing onto layer 430, the operator may snap the insert 420 out of build plate 410 as depicted in FIG. 7, and subsequently melt the layer 430 to retrieve the 3D printed object 500. The insert 420 may be gently snapped out by using a rod or other suitable tool to apply pressure to the insert 420 via hole 417 in recessed section 415 of build plate 410 (i.e., through the underside of the build plate 410). In alternative implementation, recessed section 415 may not include hole 417, and some other suitable technique may be utilized to snap the insert 420 out. In some implementations, the layer 430 may be melted and 3D printed objection 500 released before snapping out the insert.

A throughput advantage that may be realized from snapping out the insert 420 with the 3D printed object 500 is that the operator may quickly resume printing the next 3D metal printed object by snapping in a new insert 420 with applied intermediary layer 430 in the recessed section 415.

A heat treatment may be applied to the insert/3D printed object or the insert/3D printed object/build plate combination such that metal or metal alloy intermediary layer on the top side of the insert melts, releasing the 3D printed object, while the build plate, 3D printed object, and insert remain intact. The heat treatment exceeds the solidus temperature of the metal or metal alloy layer while remaining below the solidus temperature of the build plate, 3D metal printed object, and insert. A solid to liquid or solid to plastic-like phase change occurs in the metal or metal alloy layer in which the 3D metal printed object can be removed from the surface with minimal effort, without the need for mechanical removal tools such as a band saw or wire electrical discharge machinery.

A snap-in insert 420 of solid material may obviate the requirement that an operator of the 3D printing system cleans any melted material of intermediary layer from a surface of the build plate. Additionally, snap-in inserts 420 with a pre-applied intermediary layer 430 may be supplied to the operator in advance of 3D printing.

In some implementations, an operator may be supplied a container in which to place an insert (with the 3D printed object) prior to melting. The container with the insert 420 and melted material of the intermediary layer 430 may be sent back to the manufacturer of the solid insert (or some other party) to recycle the metal/metal alloy or reuse the metal/metal alloy with the same insert or a different insert.

Additional advantages may be realized via the use of a thin, intermediary lower melting temperature intermediary layer for 3D printing as discussed above with reference to FIGS. 1-7. First, the use of a thin intermediary layer may minimize the metal costs involved in 3D printing. Second, the use of a thin intermediary layer may provide improved thermal conductivity during 3D printing. Thermal conductivity is a measure of the ability of a material to transfer heat when a temperature gradient exists between opposing sides. During the 3D metal printing process, a high powered laser 205 may melt the metal powder and weld what will become the 3D printed object to the build plate. If excess energy from the laser 205 is absorbed, pooling of the low temperature metal or metal alloy could occur, which is undesirable. Applying only a thin layer of low temperature metal or metal alloy to the build plate or removable insert can help to prevent excess melting during the laser sintering process. In the case where the build plate and insert are comprised of a highly thermally conductive metal, such as aluminum or copper, the thermal conductivity of the build plate as a whole will be dominated by this material. By reducing the thickness of the low temperature intermediary layer, the heat from the laser can pass through the thin metal film without initiating a catastrophic phase change in the entire layer. The heat then reaches the build plate and is further transferred away from the build surface.

A 3D printing powder used in the 3D printing machine may range in size with 40 um grains being typical. During the 3D printing process, the laser may penetrate roughly three grains deep into the low temperature layer. To prevent the 3D object from sintering to the build plate or insert rather than to the low temperature layer, the low temperature intermediary layer thickness may exceed 120 um or roughly three grains of powder. This may depend on the factors relating to the laser 205 such as total power, laser spot size, time on spot, and pause time between laser passes. The thickness of the low temperature layer may be 120 um, 500 um, 1000 um, 2000 um or larger depending on the variables above such that the welding of the 3D printed object occurs only in the top low temperature layer and not further below into the build plate or insert. Such penetration of the welding into the build plate or main body of the insert would defeat the purpose of easy removal of the 3D printed object by thermal means from the low temperature layer.

In implementations where a layer 110 is applied on a top surface of a build plate 100, the layer 110 may have a thickness between about 100 μm and 13 mm. In some implementations, the thickness of the body of build plate 100 is between about 6 mm and 50 mm from the top surface 100a to the bottom surface 100b. The ratio of the thickness of the thermally decomposing layer 110 to the build plate 100 thickness may depend on the type of printer used with 3D metal printing device 200. For example, for smaller prototype machines this ratio may range from 50:1 to 1:1 or larger. For larger commercial machines, the ratio of the thickness of the thermally decomposing layer 110 to the build plate 100 thickness may range from 500:1 to 4:1 or larger.

In implementations where a thermally decomposing layer 430 is placed onto an insert, the insert may have a thickness between about 2 mm and 10 mm, and the thickness of the thermally decomposing layer 430 to insert 420 thickness can range from 100:1 to 1:1 or larger.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

It should be appreciated that all combinations of the foregoing concepts (provided such concepts are not mutually inconsistent) are contemplated as being part of the inventive subject matter disclosed herein. In particular, all combinations of claimed subject matter appearing in this disclosure are contemplated as being part of the inventive subject matter disclosed herein.

What is claimed is:

1. An additive manufacturing build plate, comprising:
a body including a top surface, a bottom surface, and sidewalls dimensioned such that the build plate is useable in a 3D printing device; and
a layer of a solid metal or metal alloy on the top surface of the additive manufacturing build plate, the layer having a solidus temperature that is lower than a solidus temperature of the body, and the layer configured to provide a surface for forming a 3D object in the 3D printing device.

2. The additive manufacturing build plate of claim 1, wherein the layer has a thickness between 100 μm and 13 mm.

3. The additive manufacturing build plate of claim 2, wherein the body has a thickness between 6 mm and 50 mm from the top surface to the bottom surface.

4. The additive manufacturing build plate of claim 1, wherein the additive manufacturing build plate consists of the body and the layer of the solid metal or metal alloy.

5. The additive manufacturing build plate of claim 1, wherein the layer is thermally sprayed, evaporated, wave soldered, electroplated, sputtered, painted, cladded, spin-coated, or applied by doctor blade on the top surface of the body.

6. The additive manufacturing build plate of claim 1, further comprising the 3D object printed on the layer, wherein the solid metal or metal alloy has a solidus temperature that is lower than a solidus temperature of the 3D object.

7. The additive manufacturing build plate of claim 1, wherein the body is a single part including the top surface, the bottom surface, and the sidewalls.

8. The additive manufacturing build plate of claim 1, wherein the top surface is flat.

9. The additive manufacturing build plate of claim 1, further comprising one or more holes extending through the body, the one or more holes configured to receive one or more structural protrusions of the 3D printing device to hold the additive manufacturing build plate in place during 3D printing.

10. An additive manufacturing system, comprising:
a build plate useable within a 3D printing device, the build plate including a body having a recessed section formed through a surface of the body;
an insert dimensioned to be inserted into the recessed section; and
a layer of a solid metal or metal alloy on a surface of the insert, the layer having a solidus temperature that is lower than a solidus temperature of the build plate and a solidus temperature of the insert, and the layer configured to provide a surface for forming a 3D object in the 3D printing device.

11. The additive manufacturing system of claim 10, wherein the recessed section comprises a hole extending through a bottom surface of the build plate.

12. The additive manufacturing system of claim 10, wherein layer has a thickness between 100 μm and 13 mm.

13. The additive manufacturing system of claim 12, wherein the build plate has a thickness between 6 mm and 50 mm from a top surface to a bottom surface of the build plate, and the insert has a thickness between 2 mm and 10 mm.

14. The additive manufacturing system of claim 10, wherein the layer is thermally sprayed, evaporated, wave soldered, electroplated, sputtered, painted, cladded, spin-coated, or applied by doctor blade on the surface of the insert.

15. The additive manufacturing build plate of claim 10, further comprising one or more holes extending through the body, the one or more holes configured to receive one or more structural protrusions of the 3D printing device to hold the additive manufacturing build plate in place during 3D printing.

16. A method, comprising:
obtaining a build plate useable within a 3D printing device, the build plate including a body having a recessed section formed through a surface of the body; and
securing an insert within the recessed section, the insert having a layer of a solid metal or metal alloy on a surface of the insert, and the layer having a solidus temperature that is lower than a solidus temperature of the build plate and a solidus temperature of the insert.

17. The method of claim 16, further comprising:
after securing the insert, positioning the build plate within the 3D printing device;
printing, using the 3D printing device, a 3D printed object onto the layer, wherein the layer has a lower solidus temperature than the 3D printed object; and
after printing the 3D printed object, melting the layer to release the 3D printed object from the insert.

18. The method of 17, further comprising: after printing the 3D printed object and before melting the layer: removing the insert with the 3D printed object from the recessed section of the build plate.

19. The method of 18, wherein:
the recessed section comprises a hole extending through a bottom surface of the build plate; and
removing the insert with the 3D printed object from the recessed section of the build plate, comprises: applying pressure to the insert from an underside of the build plate through the hole extending through the bottom surface of the build plate.

20. The method of claim 16, further comprising:
removing the insert with the 3D printed object from the recessed section of the build plate; and
securing, within the recessed section, a second insert.
